(19) United States
(12) Patent Application Publication
(10) Pub. No.: US 2024/0362139 A1
(43) Pub. Date: Oct. 31, 2024

(54) Systems and Methods for Custom Rules Engine for Health of Distributed Industrial Systems

(71) Applicant: A&E Engineering, Inc., Greer, SC (US)

(72) Inventor: Calvin Mark Hamus, Stevens Point, WI (US)

(21) Appl. No.: 18/644,207

(22) Filed: Apr. 24, 2024

Related U.S. Application Data
(60) Provisional application No. 63/498,989, filed on Apr. 28, 2023.

(51) Int. Cl. G06F 11/30; G06F 3/0482

(52) U.S. Cl. CPC G06F 11/3089; G06F 3/0482; G06F 11/3013

(57) ABSTRACT

Systems and methods for a custom rules engine for health of a disturbed industrial system. The system can generate an interactive user interface including a number of interactive input fields. The interactive input fields can be generated based on accessible sensor data obtained from devices located within physical facilities. The system can obtain user input data populating interactive input fields. The system can generate one or more rules based on the user input data. The system can periodically obtain sensor data from the sensors across the devices in the distributed industrial facility system. The system can compare the sensor data to the generated rules and determine if a violation has occurred. The system can provide a notification of the violation. The system can store the sensor data and record of the violation of the generated rules.

### PRIORITY

The present application claims the benefit of priority of U.S. Provisional Patent Application No. 63/498,989, filed on Apr. 28, 2023, which is incorporated by reference herein.

### FIELD

The present disclosure relates generally to improvements to computer-implemented systems and methods for a custom rules engine for providing alerts relating to the health of distributed industrial systems.

### BACKGROUND

Distributed industrial facilities can include HVAC or refrigeration systems. There can be a large number of devices within the facilities that can have malfunctions or concerning environmental factors that can cause shutdowns of various portions of facilities, damage to equipment, or potential danger to people around the devices. Current monitoring systems are complicated and provide inefficient interfaces for setting up rules for new onboarding systems or updating rules for existing systems.

### SUMMARY

Aspects and advantages of embodiments of the present disclosure will be set forth in part in the following description, or can be learned from the description, or can be learned through practice of the embodiments.

Example aspects of the present disclosure are directed to a computer-implemented method. The method can include generating an interactive user interface comprising a plurality of interactive input fields, wherein the plurality of interactive input fields are generated based at least in part on accessible sensor data obtained from one or more devices located within one or more facilities. The method can include obtaining user input data indicative of population of one or more interactive input fields. The method can include generating, based on the user input data, one or more generated rules. The method can include periodically obtaining sensor data from one or more sensors across one or more devices in the distributed industrial facility system. The method can include comparing the obtained sensor data to the one or more generated rules. The method can include determining a violation of one of the one or more generated rules. The method can include providing a notification of the violation of the one or generated more rules. The method can include storing the sensor data and recording of violation of the one or more generated rules.

In another example aspect, the present disclosure provides an example computing system. The example computing system includes one or more processors and one or more non-transitory, computer readable medium storing instructions that are executable by the one or more processors to cause the computing system to perform operations. The example operations include generating an interactive user interface comprising a plurality of interactive input fields, wherein the plurality of interactive input fields are generated based at least in part on accessible sensor data obtained from one or more devices located within one or more facilities. The operations include obtaining user input data indicative of population of one or more interactive input fields. The operations include generating, based on the user input data, one or more generated rules. The operations include periodically obtaining sensor data from one or more sensors across one or more devices in the distributed industrial facility system. The operations include comparing the obtained sensor data to the one or more generated rules. The operations include determining a violation of one of the one or more generated rules. The operations include providing a notification of the violation of the one or generated more rules. The operations include storing the sensor data and recording of violation of the one or more generated rules.

Yet another example aspect of the present disclosure is directed to one or more non-transitory, computer-readable media storing instructions comprising operations. The operations include generating an interactive user interface comprising a plurality of interactive input fields, wherein the plurality of interactive input fields are generated based at least in part on accessible sensor data obtained from one or more devices located within one or more facilities. The operations include obtaining user input data indicative of population of one or more interactive input fields. The operations include generating, based on the user input data, one or more generated rules. The operations include periodically obtaining sensor data from one or more sensors across one or more devices in the distributed industrial facility system. The operations include comparing the obtained sensor data to the one or more generated rules. The operations include determining a violation of one of the one or more generated rules. The operations include providing a notification of the violation of the one or generated more rules. The operations include storing the sensor data and recording of violation of the one or more generated rules.

Other example aspects of the present disclosure are directed to systems, computing devices, non-transitory or transitory computer-readable media, and apparatus.

### BRIEF DESCRIPTION OF THE DRAWINGS

Aspects of the disclosed technology are provided. Detailed descriptions of embodiments directed to one of ordinary skill in the art are set forth in the specification, which makes reference to the appended figures in which:

FIG. 1 depicts an example computing environment used in conjunction with sensors that can detect physical parameters associated with devices located within physical facilities to generate alerts based on rules according to example embodiments of the present disclosure;

FIG. 2 depicts a flowchart of an example method according to example embodiments of the present disclosure;

FIG. 3 depicts an example user interface according to example embodiments of the present disclosure;

FIG. 4 depicts an example user interface according to example embodiments of the present disclosure;

FIG. 5 depicts an example user interface according to example embodiments of the present disclosure;

FIG. 6 depicts an example user interface according to example embodiments of the present disclosure;

FIG. 7 depicts an example user interface according to example embodiments of the present disclosure;

FIG. 8 depicts an example user interface according to example embodiments of the present disclosure;

FIG. 9 depicts an example user interface according to example embodiments of the present disclosure;

FIG. 10 depicts an example user interface according to example embodiments of the present disclosure;

FIG. 11 depicts an example user interface according to example embodiments of the present disclosure;

FIG. 12 depicts an example user interface according to example embodiments of the present disclosure;

FIG. 13 depicts an example user interface according to example embodiments of the present disclosure;

FIG. 14 depicts an example database according to example embodiments of the present disclosure; and

FIG. 15 depicts an example computing system according to example embodiments of the present disclosure.

### DETAILED DESCRIPTION

Example aspects of the present disclosure are directed systems and methods that can provide for improved computing systems and methods for an improved user interface and data pipeline for generating and providing alerts for multiple devices located across multiple physical facilities. For instance, present methods provide for complicated systems and processes that result in inefficient processing and alert generation for distributed systems. The distributed systems can include, for instance, HVAC systems. In some implementations, a cloud service can provide a pipeline for obtaining raw data from sensors of a number of devices associated with a number of physical facility locations. The present disclosure provides for a custom rules engine that transforms expertise into logic. The present disclosure can provide for generating data which causes a user interface to provide for display information about the health of distributed industrial systems, such as HVAC and coolant systems, while eliminating manual searching for problems. Additionally, the disclosure provides for an improved data pipeline for obtaining sensor data from multiple devices across a distributed system and sorting the sensor data into privacy safe buckets which provide for access to the sensor data to be provided to authorized users.

Additionally, the pipeline allows for more efficient monitoring of large number of devices distributed across a large number of facilities by allowing for generating and/or managing a centralized data repository of sensor data across facilities while avoiding unauthorized access to data (e.g., cross-traffic among customers). The data ingestion pipeline can securely tunnel data from various facilities to associate the sets of data with certain authorization parameters to prevent the unauthorized access. For instance, a client computing device with a high level of security authorization can have access to data from sensors of all locations and devices without having to manually remote-into the various distinct systems. This allows for ease when navigating systems of different companies or locations that have distinct operating systems that historically were incompatible with each other, or cloud based operating systems.

The pipeline can obtain raw data in a number of formats. The pipeline can standardize the data format and provide a user interface for a user to generate rules based on sensor data types. For instance, the system can determine that a client has accessed an interface of the cloud monitoring system and provide an updated interface including multiple interactive user input components that can be selected to generate rules that can be genericized and applied across systems, locations, and devices.

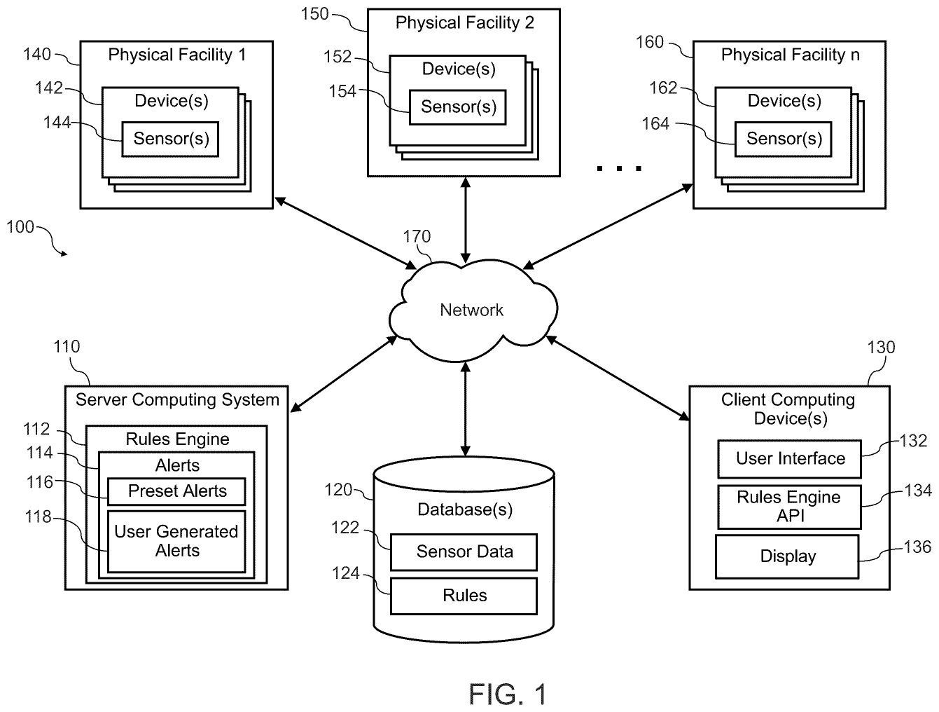

FIG. 1 depicts an example computing environment 100 in which a server computing system 110 can interact with database 120, client computing device 130, physical facility 1 140, physical facility 2 150, and physical facility n 160 over network 170. The server computing system 110 can include a rules engine 112, alerts 114, preset alerts 116, or user generated alerts 118.

Database 120 can include sensor data 122 and rules 124. Sensor data 122 can be data obtained from sensors 144, 154, 164. Sensors 144, 154, 164 can be sensors associated with devices 142, 152, 162 in a distributed industrial system. For instance, sensor data 122 can include real-time sensor data that is periodically obtained from sensors 144, 154, 164. Rules 124 can be rules associated with specific physical facilities or client computing devices.

Client computing device 130 can include user interface 132, rules engine API 134, and display 136. In some implementations client computing device 130 can be associated with all physical facilities within a computing system. In some implementations, client computing device 130 can be one or multiple computing devices. In some instances, the multiple computing devices can be associated with different authentication tokens that allow for varying degrees of access to sensor data 122 and rules 124.

For instance, client computing device 130 can be associated with an industrial facility monitoring service provider. The provider can provide monitoring services to a plurality of customers or facilities. The provider computing device can have an authentication token that allows the provider access to any device or data in computing system environment 100. However, if client computing device 130 were associated with a single physical facility, for instance, facility 1, then client computing device 130 would have an authentication token that allows client computing device 130 to only access sensor data 122 and rules 124 that are applicable to physical facility 1 140.

Physical facilities 140, 150, 160 can include one or more device(s) 142, 152, 162. Device(s) 142, 152, 162 can include one or more sensor(s) 144, 154, 164. Sensors 144, 154, 164 can be integrated according to example embodiments of the present disclosure. As shown, the sensors 144, 154, 164 can be in communication with the devices 142, 152, 162. The sensors 144, 154, 164 can be any device used to detect physical characteristics associated with devices 142, 152, 162 or the physical surroundings of the devices at a physical facility 140, 150, 160. The sensors 144, 154, 164 can include one or more thermometers, pressure sensors, humidity sensors, air quality sensors, occupancy sensors, room sensors, thermocouples, resistance temperature detectors (RTDs), thermistors, semiconductor, air flow sensors, cameras, motion sensors, optical sensors (e.g., lasers), other types of imaging capture devices, weight sensors, and/or other sensors.

The physical facility 140, 150, 160 can be any kind of distributed industrial facility. For example, the physical facility 140, 150, 160 can be an HVAC facility, refrigeration facility, or other facility. The devices 142, 152, 162 can be any kind of device located at physical facility 140, 150, 160. For example, in some embodiments, devices 142, 152, 162 can be HVAC devices. For instance, HVAC devices can include a variable air volume (VAV) unit, an air filter, a supply fan, an exhaust/relief fan, an air outlet, ducts, terminal devices, return air system, mixed air plenum and outdoor air control, heating coils, cooling coils, self-contained heating unit, self-contained cooling unit, cooling tower, boiler, control, water chiller, humidification equipment, or dehumidification equipment. Additionally, or alternatively, devices 142, 152, 162 can be refrigerator devices. For instance, refrigerator devices can include a compressor, a condenser, an expansion device, or an evaporator.

The sensors 144, 154, 164 can be in communication with a client computing device 130 and/or server computing system 110 for instance, via a network 170. In some implementations, a user can interact with user interface 132 to set one or more rules. User interface 132 can utilize rules engine API 134 to package data obtained via user interface 132 in a manner that is actionable by rules engine 112. In some embodiments, a user can control, view information, and/or specify one or more settings associated with the sensors 144, 154, 164 via user interface 132 (e.g., a graphical user interface) implemented on a display of the client computing device 130. For instance, a user can access an application implemented on the client computing device 130. The application can present a graphical user interface on a display 136 of the client computing device 130. A user can interact with the graphical user interface to interface with rules engine API 134. Rules engine API 134 can allow the user to set custom rules or confirm custom rule recommendations to be stored as rules 124 and applied to sensor data 122.

The network 170 can be a local area network and/or a wide area network. A local area network can be any suitable type of network or combination of networks that allows for communication between devices. In some embodiments, the network(s) can include one or more of a secure network, Wi-Fi network, IoT network, mesh network, one or more peer-to-peer communication links, and/or some combination thereof, and can include any number of wired or wireless links. The network 170 can be a wide area network. The wide area network can be, for instance, the Internet, cellular network, or other network, and can include any number of wired or wireless links. Communication over the network 170 can be accomplished, for instance, via a communication interface using any type of protocol, protection scheme, encoding, format, packaging, etc. As shown, the sensors 144, 154, 164 can communicate information over the network 170 to client computing device 130 and/or remote server computing system 110.

The computing environment 100 can include client computing device 130 and/or remote server computing system 110. The server computing system 110 can be associated with a cloud computing platform for implementation of one or more services for monitoring and generating alerts for distributed industrial facilities. The monitoring services can include monitoring and analyzing sensor data 122 obtained from the sensors 144, 154, 164. Data collected by the cloud computing platform can be processed and stored and provided, for instance, to a client computing device 130 (e.g., for presentation in a graphical user interface). In some instances, database 120 can be stored as part of server computing system 110. In some implementations, database 120 can be stored separately from server computing system but can be accessible by server computing system 110 via network 170.

The computing environment 100 can include remote server computing system 110. The remote server computing system 110 can be associated with the distributed industrial facilities. Data collected by the sensors 144, 154, 164 can be communicated to the remote server computing system 110 for monitoring production facility activity. Remote server computing system 110 can include rules engine 112. Rules engine can obtain user input data from rules engine API 134 to generate or set one or more rules. The rules can be stored as rules 124 in database 120. Based on the rules 124 and sensor data 122, the server computing system 110 can generate messages to be presented via display 136 of client computing device 130. For instance, the messages can include alerts 114. Alerts 114 can include preset alerts 116 or user generated alerts 118. The alerts 114 can be associated with different severity of rule violations and can be presented to a user via user interface 132 provided for display via display 136. The server computing system 110 can monitor whether alerts regarding rule violations have been resolved or acknowledged by a user (e.g., via the user providing input via user interface 132 to acknowledge the alert).

Data indicative of user input can be received by the client computing device 130 and communicated to the remote server computing system 110.

The remote server computing system 110 can include one or more computing devices (e.g., servers) having one or more processors and one or more memory devices. The client computing device 130 can have one or more processors and one or more memory devices. The server computing system 110 can be distributed such that its components are located in different geographic areas. The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

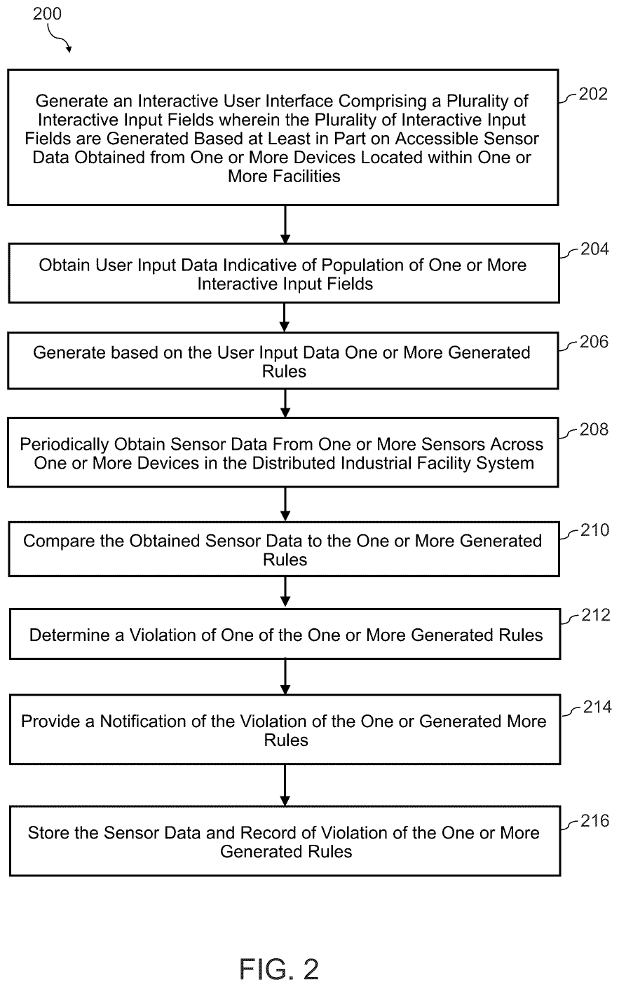

FIG. 2 depicts a flowchart of an example method 200 according to example embodiments of the present disclosure for custom rules engine for health of distributed industrial systems including providing for a simplified user interface for monitoring devices in a distributed industrial facility system. Although FIG. 2 depicts steps performed in a particular order for purposes of illustration and discussion, the methods of the present disclosure are not limited to the particularly illustrated order or arrangement. The various steps of method 200 can be omitted, rearranged, combined, or adapted in various ways without deviating from the scope of the present disclosure. Method 200 can be a computer-implemented method.

At 202, method 200 can include generating an interactive user interface comprising a plurality of interactive input fields. The plurality of interactive input fields can be generated based at least in part on accessible sensor data obtained from one or more devices located within one or more facilities. Generating the interactive user interface can be based on obtaining sensor data from a plurality of devices within a number of physical facilities within the distributed industrial facility system. The input fields can include (i) device type, (ii) a condition, and (iii) an alert type.

At 204, method 200 can include obtaining user input data indicative of population of one or more interactive input fields. For instance, interactive input fields can include rule data. Rule data can include a rule name, a rule type, and/or one or more rule conditions. A rule name can be pre-selected or generated in real-time. The rule type can include an indication of the level of concern associated with the rule type. For instance, a rule type can include “urgent”, “high priority”, “low priority”, or “informational”. The one or more rule conditions can include, for instance, a unit associated with a physical mechanical device, a qualifier, and a unit or amount. For instance, the one or more rule conditions can be associated with physical components of an HVAC system. The rule conditions can include an indication of a measurement equaling, being greater than, being less than, or being unequal to. Additionally, or alternatively, the rule can be marked as “static” or “dynamic”. A static rule indicates that the rule must stay consistent, whereas a dynamic rule can vary based on time of day, other measurements, etc. In some instances, measurements associated with particular categories, temperatures, or types of devices can vary based on time of day, day of week, presence of technicians at or near facilities housing the physical units, and the like.

At 206, method 200 can include generating, based on the user input data, one or more generated rules. Generating the one or more generated rules can include automatically generating one or more suggested rules based on at least one of historical sensor data or historical user data. For instance, a machine learning model can be trained on historical data and updated to suggest customized rules. The customized rules can be based on historical user data associated with a specific client device or can be based on sensor type or other relevant historical data. In some implementations, the model can be continuously trained and updated to provide recommended rules. In some implementations, the computing system can sort particular devices listed in the interactive user interface (e.g., drop down menus) based on predicted user selections.

For instance, a rule can be set based on an average sensor reading or a predicted sensor reading. In some instances, the customized rules or suggested rules can be generated based on current session data. By way of example, if a client device is receiving input data indicative of setting rules for alerts for sensor reading outside of an expected range (e.g., a temperature exceeding a threshold value for a certain type of machine), the rules can be suggested for additional sensors or devices that align with those rules being set (e.g., other machines of the same type having a suggested rule for providing an alert if the threshold value for the sensor is exceeded).

At 208, method 200 can include periodically obtaining sensor data from one or more sensors across one or more devices in the distributed industrial facility system. For instance, sensor data can be obtained at set intervals. In some instances, a server computing system can send a request for data to be sent by the one or more sensors. Additionally, or alternatively, the sensors and associated devices can be programmed to automatically push new sensor data. The data can be transmitted at a set interval, in response to a detected change, or in any other determined timing manner.

In some implementations, the computing system can automatically sort the sensor data and associated devices. For instance, the devices can be automatically sorted based on the location of the device. By way of example, if the industrial facility system is a school district, the location can be an individual school of the school district, or a particular wing, hallway, or other sublocation within the physical school building property. In some instances, the portions of the facility can be obtained based on user input. Additionally, or alternatively, the portions of the facility can be determined based on sensor data such as location data.

The computing system can use the sorted data to automatically generate selectable components of the generated user interface. For instance, the computing system can generate each sensor of each device as a selectable input from a drop-down menu for setting the rule in the generated interactive user interface. Thus, a rule can be set for each sensor of each device.

In some implementations, the method can include organizing the sensor data. For instance, the sensor data can be organized by receiving a plurality of datasets comprising signals obtained from a plurality of sensors on a plurality of devices within the distributed industrial facility system. The sensor data can be organized by aggregating the plurality of datasets in a database of a server computing system. The sensor data can be organized by organizing the plurality of datasets based on at least one of sensor location, sensor type, device type, device location. The sensor data can be organized by comparing the plurality of datasets to the one or more rules.

The method can include organizing the data in a structure that is capable of being processed by the rule engine. For instance, the structure of the database storage of the data including folder structure as well as file names can be applied to the data as a data ingest pipeline. For instance, the data can include a file name that is defined by the following naming convention: Location_LocationSubZone_Device_Sensor. The ingest mechanism and naming conventions can be personalized to the type of industrial facility systems that are being monitored. The file structure can be organized, for example with a location, subzone, the device, the sensor, and datapoints associated with the device or sensors.

In some implementations, the computing system can update, based on the obtained sensor data, the user interface to include selectable options that are tied to one or more physical devices associated with the distributed industrial facility system.

At 210, method 200 can include comparing the obtained sensor data to the one or more generated rules. For instance, a rule can include providing an alert if the temperature of a boiler is above two hundred degrees Fahrenheit. The system can compare a current temperature of sixty degrees to the rules of two hundred degrees. The system can determine an alert is not necessary based on this sensor measurement. However, ten minutes later, a sensor of the boiler can indicate that the temperature is two hundred and two degrees. In response, the computing system can determine that the measurement obtained by the sensor violates the generated rule.

At 212, method 200 can include determining a violation of one of the one or more generated rules. For instance, based on the comparison of the sensor data to the generated rule, the system can determine that the current state (or a previous state) of the physical environment violates the rules.

At 214, method 200 can include providing a notification of the violation of the one or more generated rules. In some implementations, the notification of the violation can include providing an individual message relating to the particular sensor or device. For instance, the user interface can provide for display, a message indicating that a violation of a rule has occurred, enumerates what rule has been violated, and/or the conditions which resulted in the violation of the rule.

In addition, or alternatively, the notification can include updating the user interface to describe an overall system state based on a plurality of rules that are set for a distributed industrial facility system. The rules can be divided into levels of severity that result in differing visual indicators of the severity of the alarm. For instance, if a rule is denoted as urgent (e.g., or an “Oh no!”), then one violation of a rule associated with this status can result in a visual indication that an action needs to be taken immediately. In some instances, the overall system state can be based on a weighted average of various system states compared to potential violation states.

This can include a thermometer, a gauge, or some other visual indication that draws attention to the alert. In some instances, there can be no urgent rules violated. Some rules can be for general information or can be used to provide context for a physical environment associated with a device. In some instances, the visual indicator can be indicative of a “Good” state where there are below a threshold number of alerts that have been activated. In some instances, the status can change from “Good” to “Warning” when the threshold number of alerts have been activated (e.g., a number of rules have been violated). In some instances, the threshold number can be a static number of alerts. In some instances, alerts can be weighted based on sensor type, device type, device location, etc. The computing system can automatically set weights based on an expected real-world impact value. The real-world impact value can be associated with a machine breaking, a potential for physical damage to a facility, or a potential for danger based on the amount of time between discovering the alert and acting upon the alert.

In some implementations, providing a notification of the violation of the one or more generated rules comprising providing one or more alerts for display. The alerts for display include at least one of a real-time alert or a historical alert. Real-time alerts can be associated with near real-time data. Such that the alert is generated based on sensor data which has been gathered or otherwise obtained within a threshold amount of time of the current time. Historical alert can be indicative of a violation of a rule at a past time. For instance, if a system pulls sensor once an hour, but obtains sensor data for points every 3 mins, a historical alert can be associated with a violation of a rule for one of those time periods, even if the most current sensor data is not indicative of a violation of a rule.

At 216, method 200 can include storing the sensor data and recording of violation of the one or more generated rules. For instance, the stored sensor data can be used to show unacknowledged historical alerts. For instance, a notification for a rule violation can persist until an input is obtained indicative of an acknowledgement of the alert. As such, the system can ensure the alert is acknowledged and not overlooked or otherwise missed. In some instances, the stored sensor data can be used to generate new rules or train a machine learning model that generates suggested rules. For instance, the sensor data can be labeled and used to train the machine learning model in a feedback loop. The sensor data can be used to predict rules based on determining a normal range for sensor data to fall between for various times of day, dates of the week, times of year, and the like.

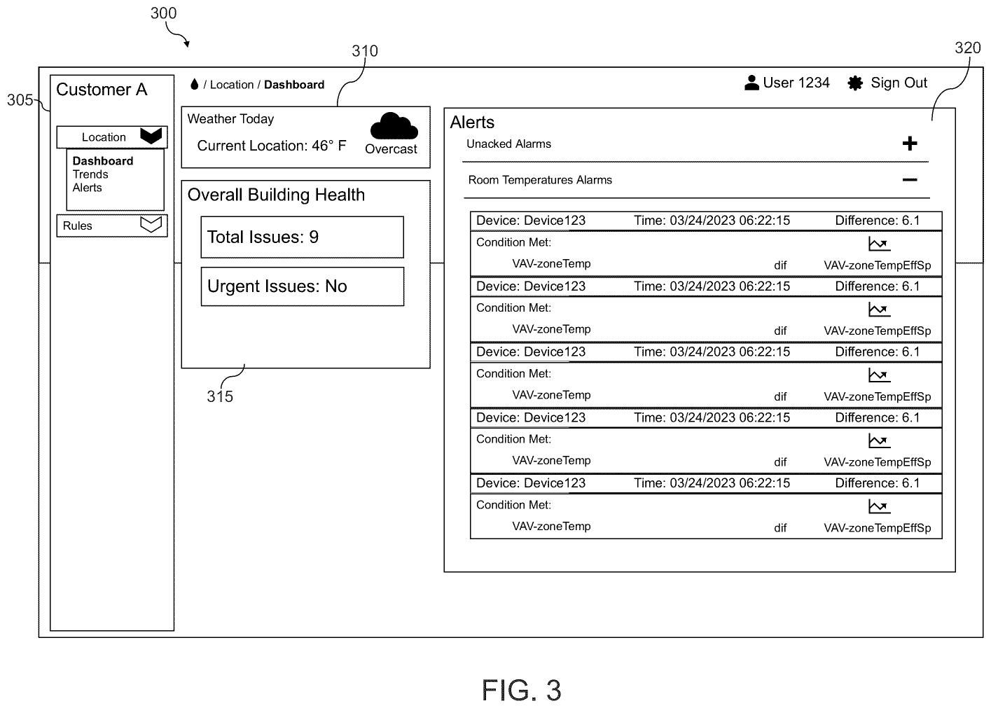

FIG. 3 depicts an example user interface 300 for the present disclosure. The user interface 300 can be a dashboard. The dashboard can include a selectable navigation menu 305. The dashboard can include an interactive element 310 comprising the weather or other location-based update. The dashboard can include an overall building health indicator 315. The overall building health indicator 315 can include a visual indication of the types of alerts. The overall building health indicator 315 can indicate a total number of issues and whether any issues are urgent. In some implementations, the overall building health can be represented in a graph form. For instance, the graph form can include a color indication associated with the status (e.g., green is good, yellow is warning, red is urgent) or a gauge. The dashboard can include an alerts user interface element 320. The alerts user interface elements 320 can include a plurality of alert types. For instance, the alert types can include unacknowledged (e.g., unacked) alarms and room temperature alarms. The alert types can be expanded to display each alert time including the device, what condition was met, what time the rule violation occurred, and any other relevant data.

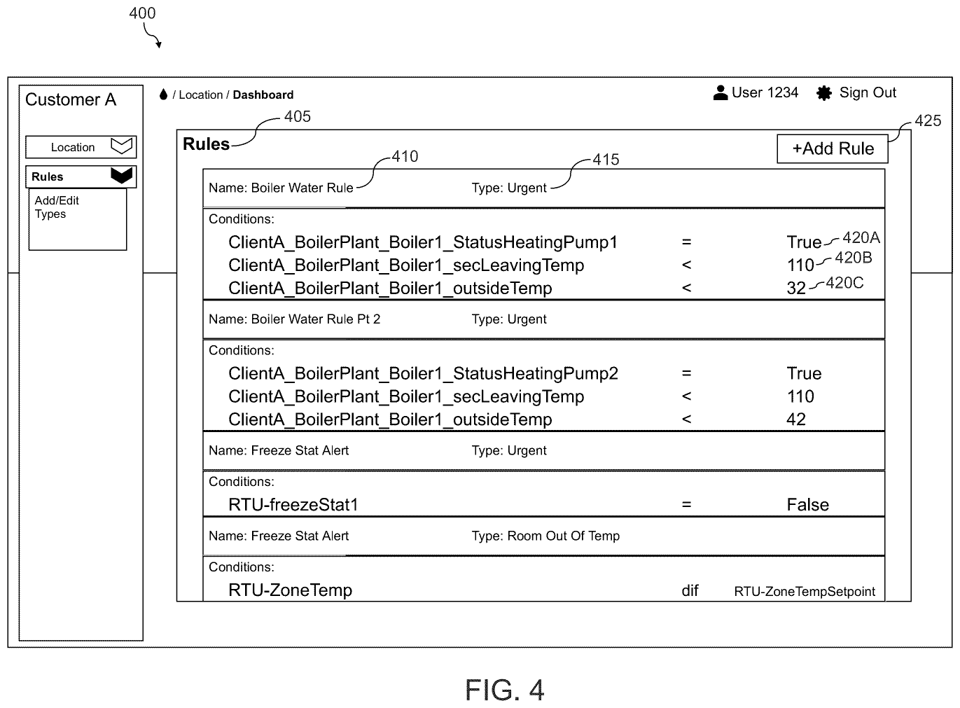

FIG. 4 depicts an example user interface 400 for the present disclosure. The user interface 400 can provide for display a plurality of rules 405 that have been generated. The rules 405 can include a rule name 410, an alert type 415, and the conditions (e.g., condition 420A, condition 420B, and/or condition 420C) associated with the rule. The user interface 400 can include an add rule selectable component 425. For instance, a rule can be generated for a water boiler at a boiler plant, a heating pump, a leaving temp, an outside temp associated with the outside, a freeze status alert, or any other rule that is manually or automatically set.

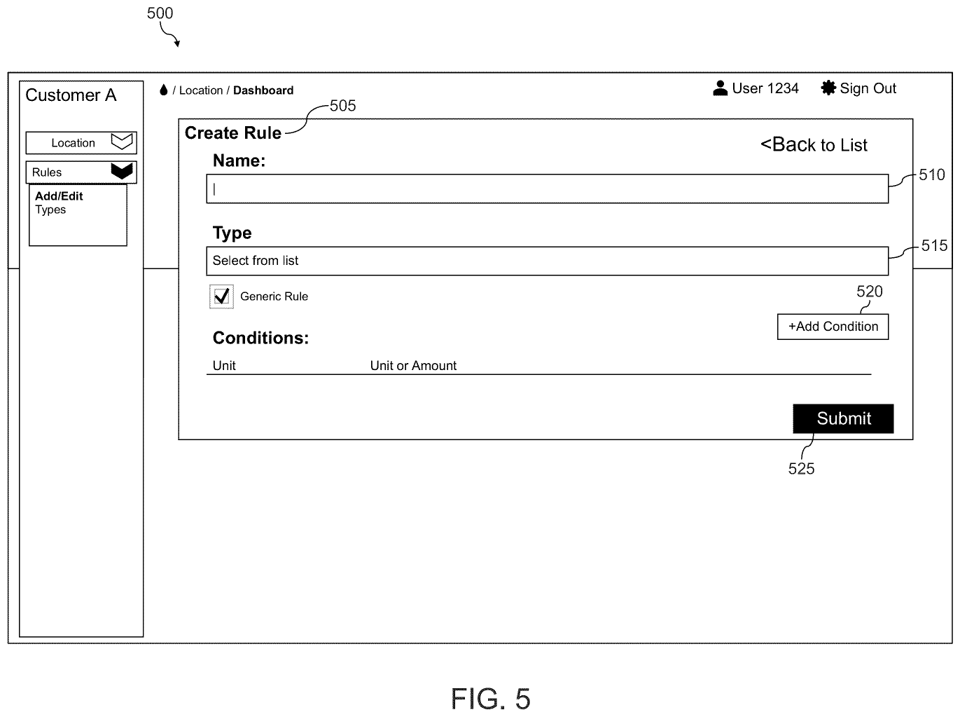

FIG. 5 depicts an example user interface 500 according to embodiments of the present disclosure. The user interface 500 can include an interactive user interface element 505 that can be utilized by a user to set up a new rule. The user interface can include an interactive input element 510 which can be a freeform input for providing a name for the rule. The user interface can include an interactive input element 515 including a drop down menu which can have alert types to select from. The user interface 500 can include an add condition selectable component 520. The add condition selectable component 520 can be selected to add a number of conditions for each respective rule that is created. When a rule is finalized, the interactive user interface element 525 can be selected to activate the rule and associated alerts.

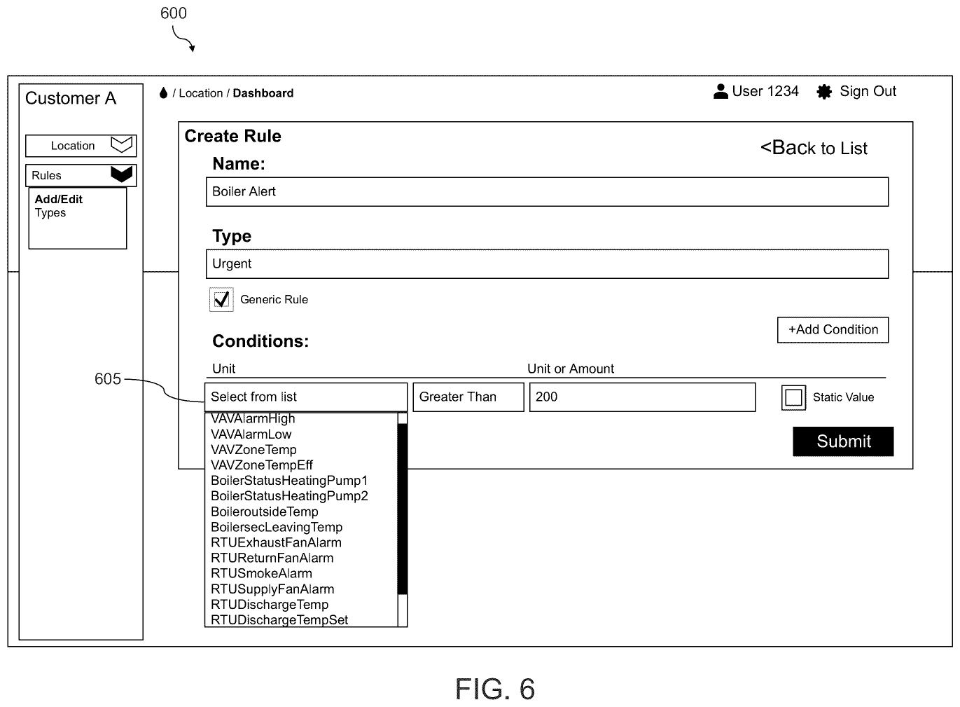

FIG. 6 depicts an example user interface 600 for the present disclosure. The user interface 600 can be updated to include a plurality of drop-down lists 605 to simplify the generation of rules. As described herein, the system can automatically populate these drop-down menus based on available sensor data and device data.

In some instances, the ordering of the drop-down menu items can be adjusted based on context data. For instance, as more conditions are added, the computing system can predict what kind of sensors or rules a user may desire to create and generate suggested conditions or emphasize particular selectable elements in the drop-down menus. Conditions can include a unit. The unit can be a device, room, or particular sensor. The user interface can include an indication of the unit being greater than, equal to, less than, or different from another unit or amount. In some instances, the conditions can be static. Additionally, or alternatively, the conditions can be static, and change based on a time of day, season, weather, or other relevant factors. By providing the interface which allows users to select options from a drop-down menu, complex rules can be generated and applied to large and complex datasets with little human interaction needed. Additionally, the present disclosure allows for generation of rules that can be applied across multiple devices, locations, or companies based on their relevance. This can allow for better monitoring and management of distributed industrial facility systems and provide for safer environments as well as more efficient utilizations of energy by improving the performance of physical devices within the distributed industrial facility system.

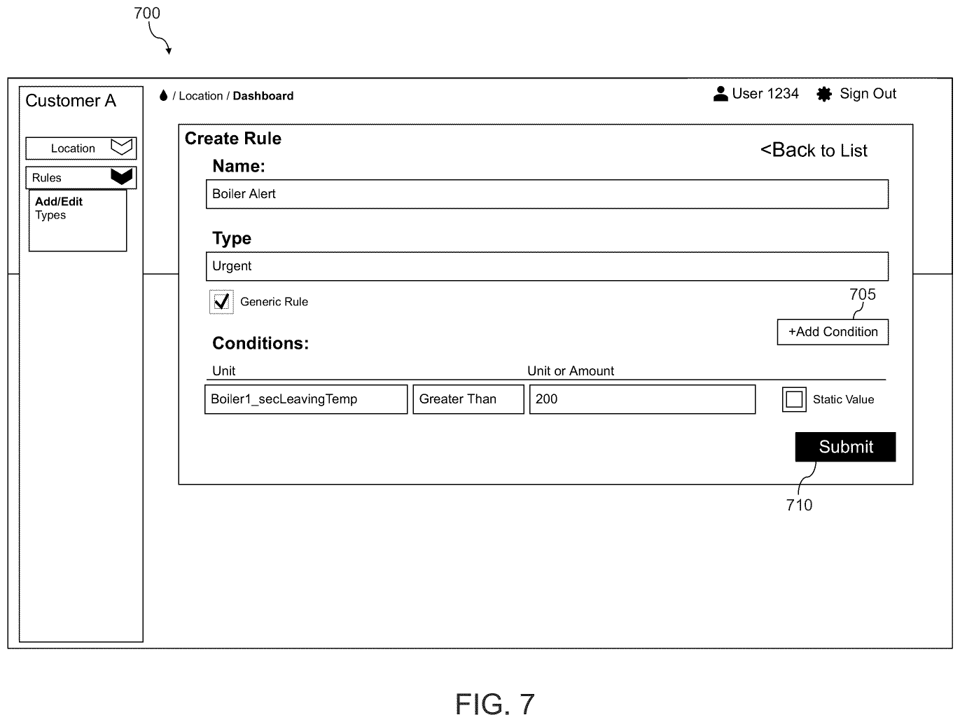

FIG. 7 depicts an example user interface 700 for the present disclosure. The user interface can include a means for adding one or more conditions (e.g., via selectable component 705) to a rule and submitting the rule (e.g., via selectable component 710). Upon submission of the rule, the rule will be applied to future sensor data that is obtained. For instance, once submitted, the rule can be activated.

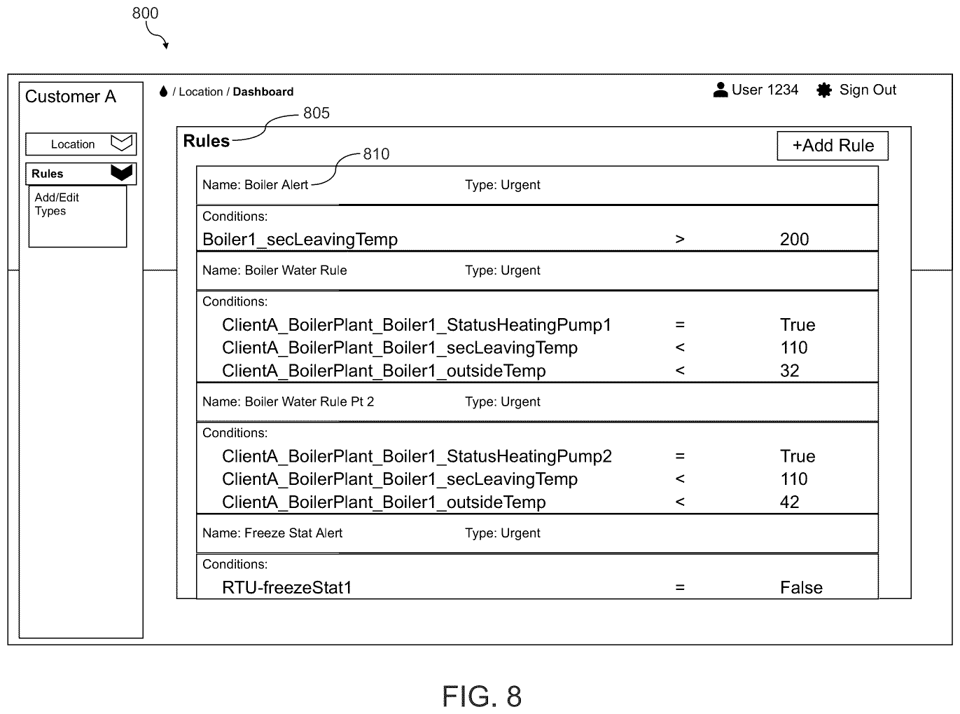

FIG. 8 depicts an example user interface 800 for the present disclosure. The user interface 800 can include an updated rules interface 805 that includes the rule 810 that was newly generated as depicted in FIG. 6 and FIG. 7.

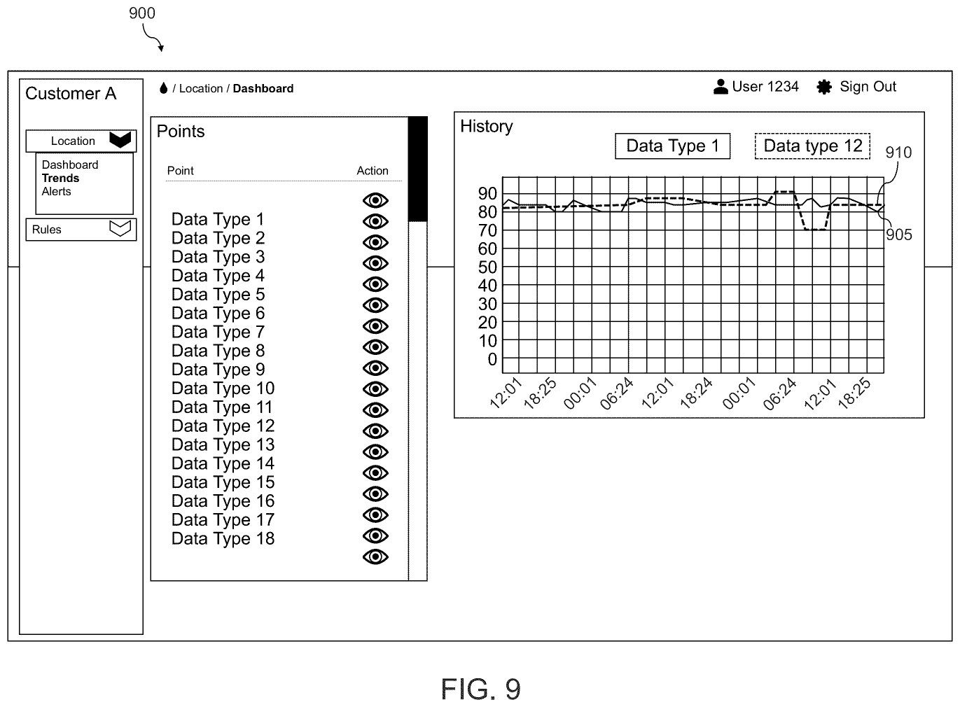

FIG. 9 depicts an example user interface 900 for the present disclosure. The user interface 900 can display information of trends for specific sensor data from specific devices over a period of time. FIG. 9 depicts an example trend line depicting data type 1 905 and data type 2 910.

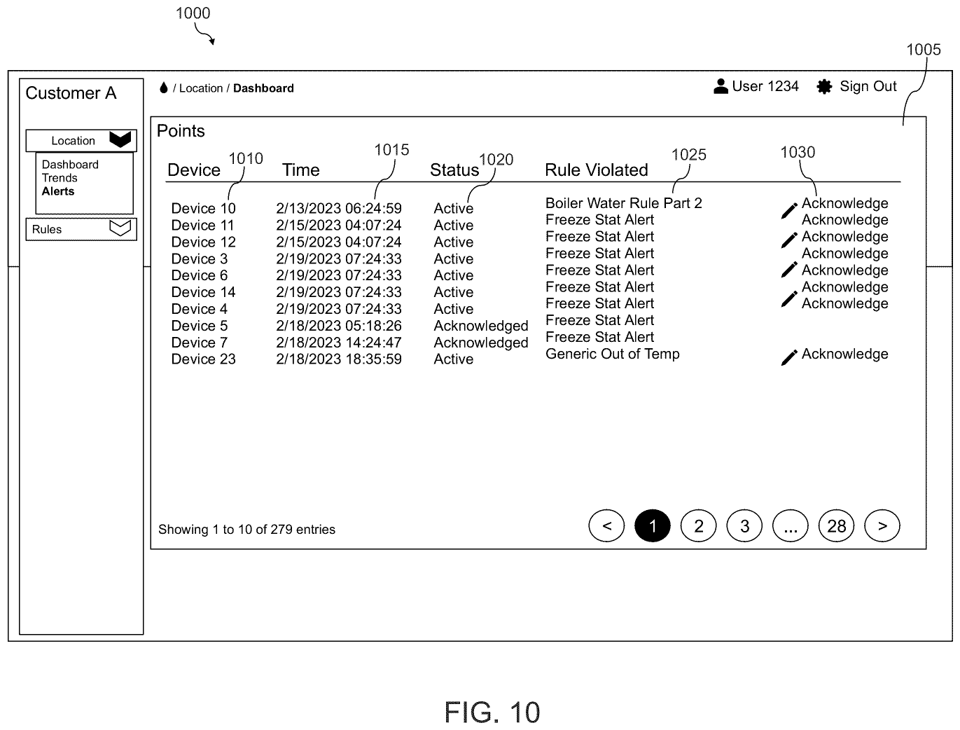

FIG. 10 depicts an example user interface 1000 for the present disclosure. The user interface 1000 can display a summary of alerts. The summary of alerts 1005 can include the device associated with the alert 1010, the time of the alert 1015, the status of the alert 1020, what rule was violated 1025, and a selectable element to acknowledge the alert 1030. For instance, the user interface can display a plurality of alerts for a number of devices. This can include acknowledged alerts for device 5 and device 7 as well as unacknowledged alerts for device 10, device 11, device 12, device 3, device 6, device 14, device 4, and device 23.

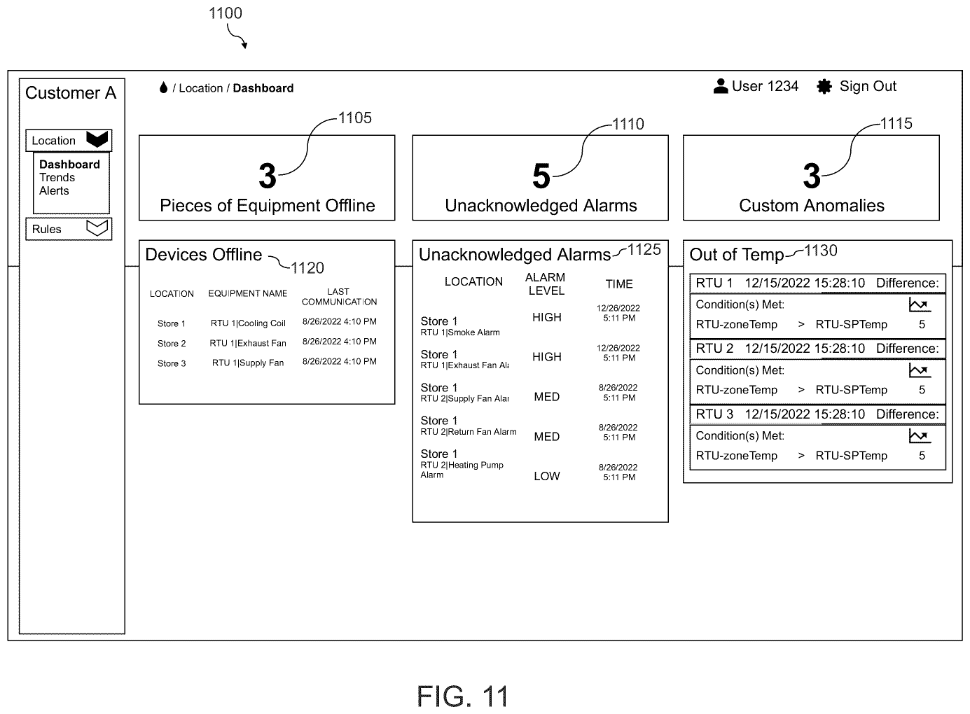

FIG. 11 depicts an example user interface 1100 for the present disclosure. The user interface 1100 can display a number of devices offline 1105, a number of unacknowledged alarms 1110, and a number of custom anomalies 1115. The user interface can display these values in a manner that makes it easy to grasp a large amount of data (e.g., status of hundreds or thousands of sensors across a distributed industrial facility system) utilizing a small amount of user interface space. The user interface can display a more detailed view of the above-mentioned data types. For instance, the devices offline can include location, equipment name, and time of last communication for the offline devices as depicted in expanded view 1120. The unacknowledged alarms can include a location, alarm level, and time associated with the unacknowledged alarms as depicted in expanded view 1125. The custom anomalies can be user specific, location specific, or device specific anomalies that a user would like to be provided for display but would not ordinarily be provided for display (e.g., as a default setting) as depicted in expanded view 1130.

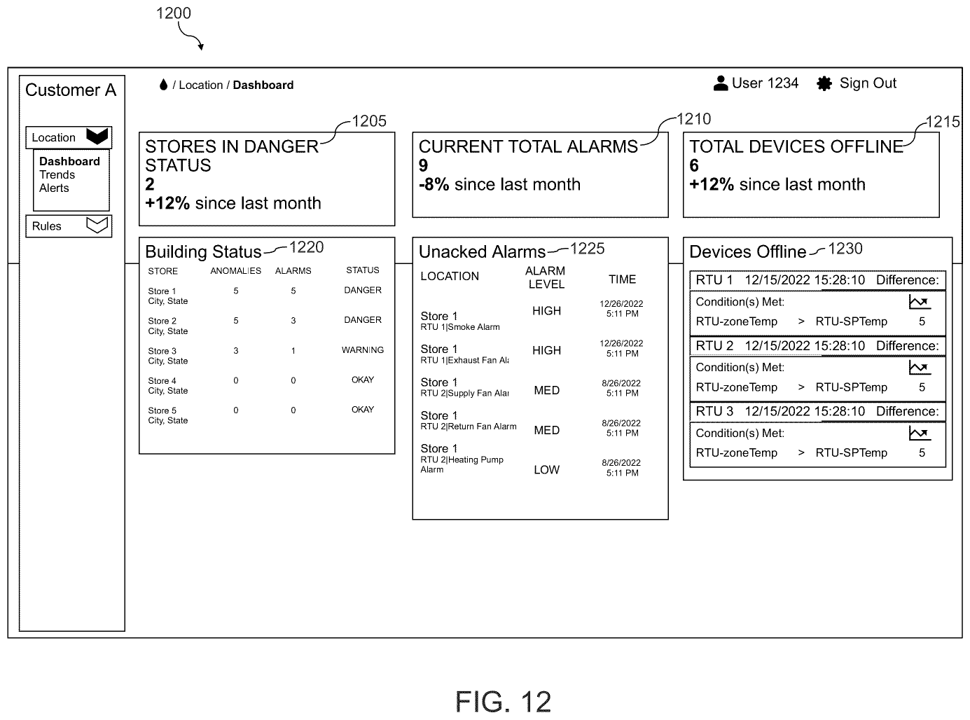

FIG. 12 depicts an example user interface 1200 for the present disclosure. The user interface 1200 can display a number of stores in danger 1205, a number of current total alarms 1210, a number of total devices offline 1215. The number of stores in danger can include a summary of building statuses 1220 including which are of an urgent or danger status. For instance, the building status 1220 can include a store name, location, a number of anomalies, a number of alarms, and a status (e.g., danger, warning, okay). The user interface can additionally include how this number compares to a previous count (e.g., by week, month, year, etc.). The current total alarms can include a summary of unactioned alarms 1225 Including location, alarm level, and time. The devices offline 1230 can include a device name, a time, what conditions were last met at the time the device went offline, or other relevant information.

As described herein, the user interface 1200 is highly customizable to provide increased visibility into the current physical health of a plurality of sensors and devices across a distributed industrial facility system.

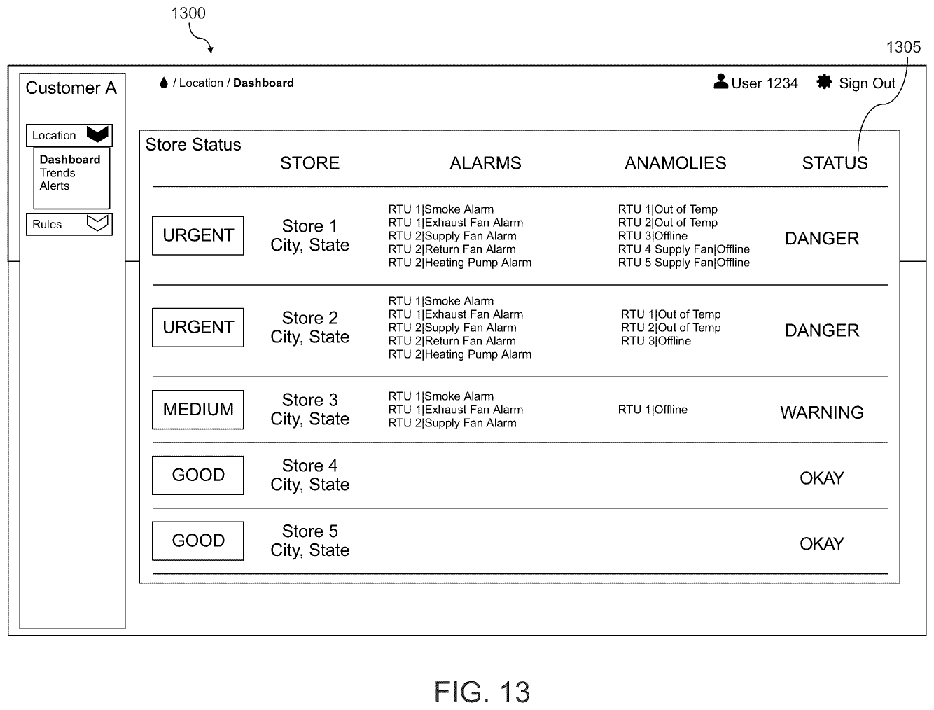

FIG. 13 depicts an example user interface 1300 for the present disclosure. The user interface 1300 can display a larger view of store statuses. For example, the user interface can include a visual or other graphical depiction of the store status 1305 (e.g., an indication of urgent, medium, or good). The visual indication can include a color-coded indication associated with the severity of the status. The visual indication can include a gauge or some other visual indication of the store status. The store status user interface can include the store name, the store location, a listing of the active alarms (e.g., unacknowledged alarms), an indication of active anomalies, and the status (e.g., danger, warning, okay).

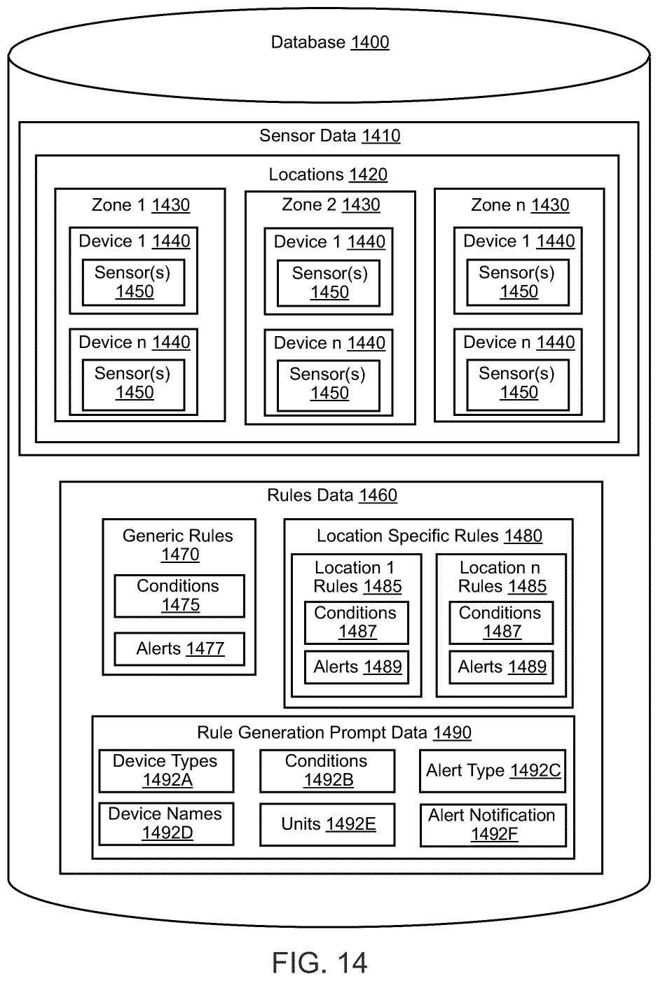

FIG. 14 depicts an expanded view of an example database (e.g., database 120 of FIG. 1). Database 1400 can include sensor data 1410 and rules data 1460. Sensor data 1410 can include sensor data from a plurality of locations. For example, the locations can include location 1420. Location 1420 can include one or more zones 1430. Each of the one or more zones 1430 can include one or more devices 1440. Each of the one or more devices 1440 can include one or more sensors 1450.

Rules data 1460 can include generic rules 1470, location specific rules 1480, or rules generation prompt data 1490. Generic rules 1470 can include conditions 1475 or alerts 1477. Generic rules can apply to any system. The rules data 1460 can indicate rules that have been generated or are in use by one or more client computing devices for monitoring one or more locations. Location specific rules 1480 can be rules that are specific to a certain location or zone associated with an industrial facility system. Location specific rules 1480 can include rules for one or more locations 1485. The location rules for the one or more locations 1485 can include conditions 1487 or alerts 1489. Rule generation prompt data 1490 can include data to be utilized in the user interface for generating the rules. For instance, rule generation prompt data 1490 can include device types 1492A, conditions 1492B, alert types 1492C, device names 1492D, units 1492E, alert notifications 1492F. As described herein, the rule generation prompt data 1490 can be pre-populated information. Additionally, or alternatively, the rule generation prompt data 1490 can be generated based on sensor data or historical data (e.g., associated with the system as a whole or a specific client device or location identifier.

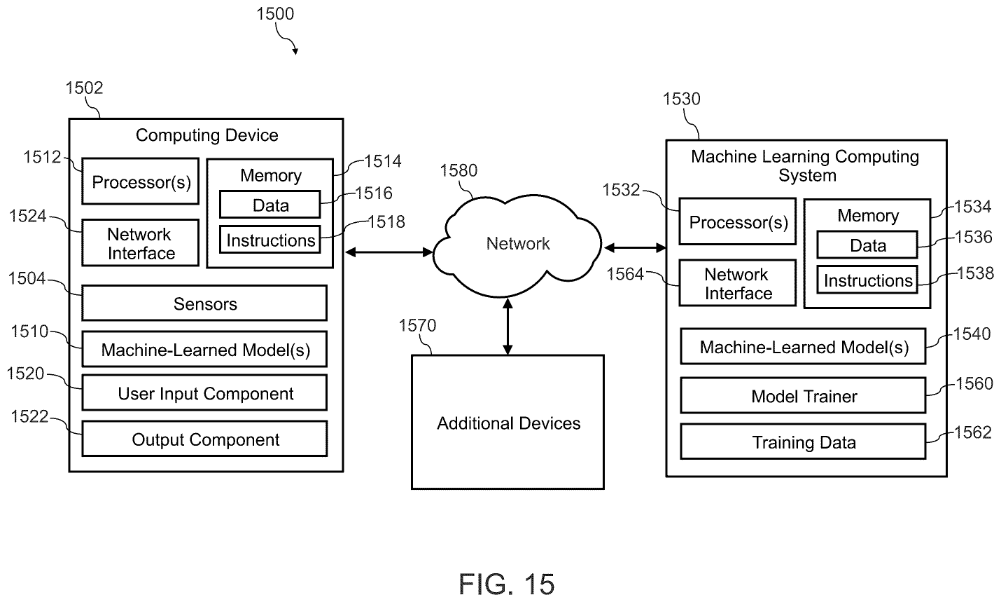

FIG. 15 depicts an example computing system 1500 for machine-learning-based generation of rules and monitoring of sensors and devices across a distributed industrial facility system according to example embodiments of the present disclosure. The example computing system 1500 includes a computing device 1502 and a machine learning computing system 1530 that are communicatively coupled over a network 1580.

The computing device 1502 includes one or more processors 1512 and a memory 1514. The one or more processors 1512 can be any suitable processing device (e.g., a processor core, a microprocessor, an ASIC, a FPGA, a controller, a microcontroller, etc.) and can be one processor or a plurality of processors that are operatively connected. The memory 1514 can include one or more non-transitory computer-readable storage media, such as RAM, ROM, EEPROM, EPROM, one or more memory devices, flash memory devices, etc., and combinations thereof.

The memory 1514 can store information that can be accessed by the one or more processors 1512. For instance, the memory 1514 (e.g., one or more non-transitory computer-readable storage mediums, memory devices) can store data 1516 that can be obtained, received, accessed, written, manipulated, created, and/or stored. In some implementations, the computing device 1502 can obtain data from one or more memory device(s) that are remote from the device 1502.

The memory 1514 can also store computer-readable instructions 1518 that can be executed by the one or more processors 1512. The instructions 1518 can be software written in any suitable programming language or can be implemented in hardware. Additionally, or alternatively, the instructions 1518 can be executed in logically and/or virtually separate threads on processor(s) 1512.

For example, the memory 1514 can store instructions 1518 that when executed by the one or more processors 1512 cause the one or more processors 1512 to perform any of the operations and/or functions described herein.

According to an aspect of the present disclosure, the computing device 1502 can store or include one or more machine-learned models 1510. For example, the models 1510 can be or can otherwise include various machine-learned models such as a random forest classifier; a logistic regression classifier; a support vector machine; one or more decision trees; a neural network; and/or other types of models including both linear models and non-linear models. Example neural networks include feed-forward neural networks, recurrent neural networks (e.g., long short-term memory recurrent neural networks), convolutional neural networks, or other forms of neural networks.

In some implementations, the computing device 1502 can receive the one or more machine-learned models 1510 from the machine learning computing system 1530 over network 1580 and can store the one or more machine-learned models 1510 in the memory 1514. The computing device 1502 can then use or otherwise run the one or more machine-learned models 1510 (e.g., by processor(s) 1512).

The machine learning computing system 1530 includes one or more processors 1532 and a memory 1534. The one or more processors 1532 can be any suitable processing device (e.g., a processor core, a microprocessor, an ASIC, a FPGA, a controller, a microcontroller, etc.) and can be one processor or a plurality of processors that are operatively connected. The memory 1534 can include one or more non-transitory computer-readable storage media, such as RAM, ROM, EEPROM, EPROM, one or more memory devices, flash memory devices, etc., and combinations thereof.

The memory 1534 can store information that can be accessed by the one or more processors 1532. For instance, the memory 1534 (e.g., one or more non-transitory computer-readable storage mediums, memory devices) can store data 1536 that can be obtained, received, accessed, written, manipulated, created, and/or stored. In some implementations, the machine learning computing system 1530 can obtain data from one or more memory device(s) that are remote from the system 1530.

The memory 1534 can also store computer-readable instructions 1538 that can be executed by the one or more processors 1532. The instructions 1538 can be software written in any suitable programming language or can be implemented in hardware. Additionally, or alternatively, the instructions 1538 can be executed in logically and/or virtually separate threads on processor(s) 1532.

For example, the memory 1534 can store instructions 1538 that when executed by the one or more processors 1532 cause the one or more processors 1532 to perform any of the operations and/or functions described herein.

In some implementations, the machine learning computing system 1530 includes one or more server computing devices. If the machine learning computing system 1530 includes multiple server computing devices, such server computing devices can operate according to various computing architectures, including, for example, sequential computing architectures, parallel computing architectures, or some combination thereof.

In addition, or alternatively to the model(s) 1510 at the computing device 1502, the machine learning computing system 1530 can include one or more machine-learned models 1540. For example, the models 1540 can be or can otherwise include various machine-learned models such as a random forest classifier; a logistic regression classifier; a support vector machine; one or more decision trees; a neural network; and/or other types of models including both linear models and non-linear models. Example neural networks include feed-forward neural networks, recurrent neural networks (e.g., long short-term memory recurrent neural networks), convolutional neural networks, or other forms of neural networks.

As an example, the machine learning computing system 1530 can communicate with the computing device 1502 according to a client-server relationship. For example, the machine learning computing system 1540 can implement the machine-learned models 1540 to provide a web service to the computing device 1502.

Thus, machine-learned models 1510 can be located and used at the computing device 1502 and/or machine-learned models 1540 can be located and used at the machine learning computing system 1530.

In some implementations, the machine learning computing system 1530 and/or the computing device 1502 can train the machine-learned models 1510 and/or 1540 through use of a model trainer 1560. The model trainer 1560 can train the machine-learned models 1510 and/or 1540 using one or more training or learning algorithms. One example training technique is backwards propagation of errors (“backpropagation”).

In some implementations, the model trainer 1560 can perform supervised training techniques using a set of labeled training data 1562. In other implementations, the model trainer 1560 can perform unsupervised training techniques using a set of unlabeled training data. The model trainer 1560 can perform a number of generalization techniques to improve the generalization capability of the models being trained. Generalization techniques include weight decays, dropouts, or other techniques. The model trainer 1560 can be implemented in hardware, software, firmware, or combinations thereof.

The computing device 1502 can also include a network interface 1524 used to communicate with one or more systems or devices, including systems or devices that are remotely located from the computing device 1502. The network interface 1524 can include any circuits, components, software, etc. for communicating with one or more networks (e.g., 1580). In some implementations, the network interface 1524 can include, for example, one or more of a communications controller, receiver, transceiver, transmitter, port, conductors, software and/or hardware for communicating data. Similarly, the machine learning computing system 1530 can include a network interface 1564.

The computing device 1502 can also include one or more sensors 1504. For example, the one or more sensors 1504 can include any type of sensor useful to collect data about an environment of the computing device 1502.

The computing device 1502 can also include a user input component 1520. For example, the user input component 1520 can include a microphone, a keypad, a keyboard, a click-wheel, buttons, and/or a touch-sensitive screen.

The computing device 1502 can also include an output component 1522. For example, the output component 1522 can include a speaker, a haptic output component, and/or a display (e.g., a touch-sensitive display).

As another example, the computing device 1502 can transmit information to one or more additional devices 1570 (e.g., network devices, etc.). The computing device 1502 can communicate with the additional computing device(s) 1570 over the network 1580 and/or via a local, short-range wireless communication protocol (e.g., Bluetooth).

The network(s) 1580 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 1580 can be accomplished, for instance, via a network interface using any type of protocol, protection scheme, encoding, format, packaging, etc.

FIG. 15 illustrates one example computing system 1500 that can be used to implement the present disclosure. Other computing systems can be used as well. For example, in some implementations, the computing device 1502 can include the model trainer 1560 and the training dataset 1562. In such implementations, the machine-learned models 1510 can be both trained and used locally at the computing device 1502. As another example, in some implementations, the computing device 1502 is not connected to other computing systems.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for a simplified user interface for monitoring devices in a distributed industrial facility system, comprising:
generating an interactive user interface comprising a plurality of interactive input fields, wherein the plurality of interactive input fields are generated based at least in part on accessible sensor data obtained from one or more devices located within one or more facilities;
obtaining user input data indicative of population of one or more interactive input fields;
generating, based on the user input data, one or more generated rules;
periodically obtaining sensor data from one or more sensors across one or more devices in the distributed industrial facility system;
comparing the obtained sensor data to the one or more generated rules;
determining a violation of one of the one or more generated rules;
providing a notification of the violation of the one or generated more rules; and
storing the sensor data and record of violation of the one or more generated rules.

2. The computer-implemented method of claim 1, wherein generating the interactive user interface is based on obtaining sensor data from a plurality of devices within a plurality of physical facilities within the distributed industrial facility system.

3. The computer-implemented method of claim 2, comprising:
automatically sorting the devices based on the location of the devices; and
generating each sensor of each device as a selectable input from a drop-down menu for setting the rule in the generated interactive user interface.

4. The computer-implemented method of claim 3, comprising:
updating, based on the obtained sensor data, the user interface to include selectable options that are tied to one or more physical devices associated with the distributed industrial facility system.

5. The computer-implemented method of claim 1, wherein the input fields comprise: (i) device type, (ii) a condition, and (iii) an alert type.

6. The computer-implemented method of claim 1, comprising:
automatically generating one or more suggested rules based on historical sensor/user data.

7. The computer-implemented method of claim 1, wherein providing a notification of the violation of the one or more generated rules comprising providing one or more alerts for display, wherein the alerts for display include at least one of a real-time alert or a historical alert.

8. The computer-implemented method of claim 1, comprising:
organizing the sensor data by:
receiving a plurality of datasets comprising signals obtained from a plurality of signals on a plurality of devices within the distributed industrial facility system;
aggregating the plurality of datasets in a database of a server computing system;
organizing the plurality of datasets based on at least one of sensor location, sensor type, device type, device location; and
comparing the plurality of datasets to the one or more rules.

9. A computing system for a simplified user interface for monitoring devices in a distributed industrial facility system, comprising:
one or more processors; and
one or more transitory or non-transitory computer-readable media storing instructions that are executable to cause the one or more processors to perform operations, the operations comprising:
generating an interactive user interface comprising a plurality of interactive input fields, wherein the plurality of interactive input fields are generated based at least in part on accessible sensor data obtained from one or more devices located within one or more facilities;
obtaining user input data indicative of population of one or more interactive input fields;
generating, based on the user input data, one or more generated rules;
periodically obtaining sensor data from one or more sensors across one or more devices in the distributed industrial facility system;
comparing the obtained sensor data to the one or more generated rules;
determining a violation of one of the one or more generated rules;
providing a notification of the violation of the one or generated more rules; and
storing the sensor data and record of violation of the one or more generated rules.

10. The computing system of claim 9, wherein generating the interactive user interface is based on obtaining sensor data from a plurality of devices within a plurality of physical facilities within the distributed industrial facility system.

11. The computing system of claim 10, the operations comprising:
automatically sorting the devices based on the location of the devices; and
generating each sensor of each device as a selectable input from a drop-down menu for setting the rule in the generated interactive user interface.

12. The computing system of claim 10, the operations comprising:
updating, based on the obtained sensor data, the user interface to include selectable options that are tied to one or more physical devices associated with the distributed industrial facility system.

13. The computing system of claim 9, wherein the input fields comprise: (i) device type, (ii) a condition, and (iii) an alert type.

14. The computing system of claim 9, the operations comprising:
automatically generating one or more suggested rules based on historical sensor/user data.

15. The computing system of claim 9, wherein providing a notification of the violation of the one or more generated rules comprising providing one or more alerts for display, wherein the alerts for display include at least one of a real-time alert or a historical alert.

16. The computing system of claim 9, the operations comprising:
organizing the sensor data by:
receiving a plurality of datasets comprising signals obtained from a plurality of signals on a plurality of devices within the distributed industrial facility system;
aggregating the plurality of datasets in a database of a server computing system;
organizing the plurality of datasets based on at least one of sensor location, sensor type, device type, device location; and
comparing the plurality of datasets to the one or more rules.

17. One or more non-transitory computer readable media for a simplified user interface for monitoring devices in a distributed industrial facility system, storing instructions that are executable by one or more processors to perform operations comprising:
generating an interactive user interface comprising a plurality of interactive input fields, wherein the plurality of interactive input fields are generated based at least in part on accessible sensor data obtained from one or more devices located within one or more facilities;
obtaining user input data indicative of population of one or more interactive input fields;
generating, based on the user input data, one or more generated rules;
periodically obtaining sensor data from one or more sensors across one or more devices in the distributed industrial facility system;
comparing the obtained sensor data to the one or more generated rules;
determining a violation of one of the one or more generated rules;
providing a notification of the violation of the one or generated more rules; and
storing the sensor data and record of violation of the one or more generated rules.

18. The one or more non-transitory computer-readable media of claim 17, wherein generating the interactive user interface is based on obtaining sensor data from a plurality of devices within a plurality of physical facilities within the distributed industrial facility system.

19. The one or more non-transitory computer-readable media of claim 18, the operations comprising:
automatically sorting the devices based on the location of the devices; and
generating each sensor of each device as a selectable input from a drop-down menu for setting the rule in the generated interactive user interface.

20. The one or more non-transitory computer-readable media of claim 18, the operations comprising:
updating, based on the obtained sensor data, the user interface to include selectable options that are tied to one or more physical devices associated with the distributed industrial facility system.
